(19) United States
(12) Patent Application Publication
(10) Pub. No.: US 2006/0206673 A1
(43) Pub. Date: Sep. 14, 2006

(54) Method for controlling access of dynamic random access memory module

(75) Inventors: Ying-Chih Lu, Taipei (TW); Ling-Hung Yu, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/076,642

(22) Filed: Mar. 8, 2005

(51) Int. Cl. G06F 13/00; G06F 12/00; G06F 9/24

(52) U.S. Cl. 711/154; 711/105; 713/2

(57) ABSTRACT

A method for controlling access for a DRAM module applicable to a substrate provided with at least a DRAM module slot of either a first or second specification, a memory controller and a BIOS program is proposed. Thus, access control for first and second DRAM modules installed in the DRAM module slots can be performed. The first and second DRAM module related data is pre-stored by the BIOS program. Then, a memory initialization process is performed by the substrate according to the BIOS program, such that the memory controller access the DRAM module provided on the substrate during the memory initialization process, and serial present detect (SPD) data of the DRAM module is read using an I2C protocol via a system management (SM) bus, so as to determine whether the DRAM module installed in the DRAM module slot is the first DRAM module or the second DRAM module according to a value in a memory type field of the SPD data. Finally, with the determined DRAM module, the DRAM module related data corresponding to the DRAM module is read from the BIOS program by the memory controller, so as to achieve access control for the DRAM module.

### FIELD OF THE INVENTION

The present invention relates to a method for controlling access of a dynamic random access memory (DRAM) module, and more particularly, to a method for controlling access of a DRAM module which enables a memory controller to access a DDR-I DRAM DIMM or a DDR-II DRAM DIMM using the same BIOS program.

### BACKGROUND OF THE INVENTION

As a dynamic random access memory (DRAM) is characterized with a large storage capacity and a low cost, it is usually employed as a preferred memory scheme for various electronic products (such as desktop computers, notebook computers, servers or workstations, etc.), making it one of essential components in the electronic product.

Further, to improve transmission speed for the DRAM, different DRAMs such as a double data rate-I (DDR-I) DRAM and a double data rate-II (DDR-II) DRAM are developed by the manufacturers. Dual in-line memory module (DIMM) slots are used for inserting DRAM DIMMs of two specifications into a substrate. Generally, different DRAM (i.e. DDR-I DRAM and DDR-II DRAM) DIMMs have different corresponding DIMM slots.

In the coordination of the DRAM modules of two specifications, such as DDR-I DRAM DIMM (abbreviated as DDR-I DIMM) and DDR-II DRAM DIMM (abbreviated as DDR-II DIMM), Intel Corporation has developed a Lindenhurst chipset having a memory controller (the Lindenhurst chipset is named as a Lindenhurst memory chipset) to support the DDR-I DIMM and the DDR-II DIMM. FIGS. 1(A) and 1(B) are block diagrams showing basic constructions of a substrate 7 and 7′ which respectively employs a DDR-I DRAM DIMM slot and a DDR-II DRAM DIMM slot. Two substrates (7 and 7′) employ the same memory controller 1 (such as the Lindenhurst memory chipset proposed by the Intel Corporation) and respectively use a DDR-I DIMM slot area 2 and a DDR-II DIMM slot area 2′. Each of the DDIM slot areas (2 and 2′) comprises 8 DIMM slots (20, 21 . . . 27 and 20′, 21′ . . . 27′). Further, six DIMM slots of each of the two DIMM slot areas (2 and 2′) are respectively installed with DDR-I DRAM DIMMs 3 and DDR-II DRAM DIMMs 4.

The DDR-I DRAM DIMM 3 and the DDR-II DRAM DIMM 4 are incompatible with different hardware designs. So, while the DDR-I DRAM DIMM 3 and the DDR-II DRAM DIMM 4 can be both supported by the Lindenhurst memory chipset developed by the Intel Corporation, when the two memory modules cannot be simultaneously supported, different BIOS programs (5 and 5′) need to be installed on the substrates (7 and 7′) in order for the Lindenhurst memory chipset to determine specifications of the DIMM slot areas (2 and 2′) for the memory modules whose access control is performed by the Lindenhurst memory chipset.

Accordingly, the foregoing method has caused inconveniences in BIOS program designs, BIOS program burning and a substrate testing. Therefore, it is a current issue to provide a method for controlling access of a dynamic random access memory module, whereby a desirable substrate that supports the DDR-I DIMM or the DDR-II DIMM using the Lindenhurst memory chipset is designed and fabricated using the same BIOS program by electronic product manufacturers.

### SUMMARY OF THE INVENTION

In light of the above prior-art drawbacks, an objective of the present invention is to provide an access control method for a dynamic random access memory module, by which access control of a DDR-I DRAM DIMM or a DDR-II DRAM DIMM can be performed by a memory controller using the same BIOS program. In accordance with the above and other objectives, the present invention proposes an access control method for a dynamic random access memory module. The access control method for a dynamic random access memory module proposed in the present invention is applicable to a substrate provided with at least a dynamic random access memory (DRAM) module slot with a first specification or a second specification, a memory controller and a basic input/output system (BIOS) program, such that access control of a first DRAM module installed in the DRAM module slot of the first specification or a second DRAM module installed in the DRAM module slot of the second specification can be performed. First of all, the first and second DRAM module related data is pre-stored by the BIOS program. Then, a memory initialization process is performed by the substrate according to the BIOS program. Subsequently, the memory module installed on the substrate is accessed by the memory controller during the memory initialization process. Also, serial present detect (SPD) data of the memory module is read using an I2C protocol and a system management (SM) bus so as to determine whether the memory module installed in the DRAM module slot is a first DRAM module or a second DRAM module according to a value in a memory type field of SPD data of the DRAM module. Finally, the memory controller reads the DRAM module related data from the BIOS program according to the detected DRAM module, so that access control for the DRAM module installed in the DRAM module slot can be performed by the memory controller according to the DRAM module related data.

### BRIEF DESCRIPTION OF THE DRAWINGS

The present invention can be more fully understood by reading the following detailed description of the preferred embodiments, with reference made to the accompanying drawings, wherein:

FIG. 1(A) and FIG. 1(B) are block diagrams showing basic constructions of substrates employing a DDR-I DRAM DIMM and a DDR-II DRAM DIMM respectively as memory modules.

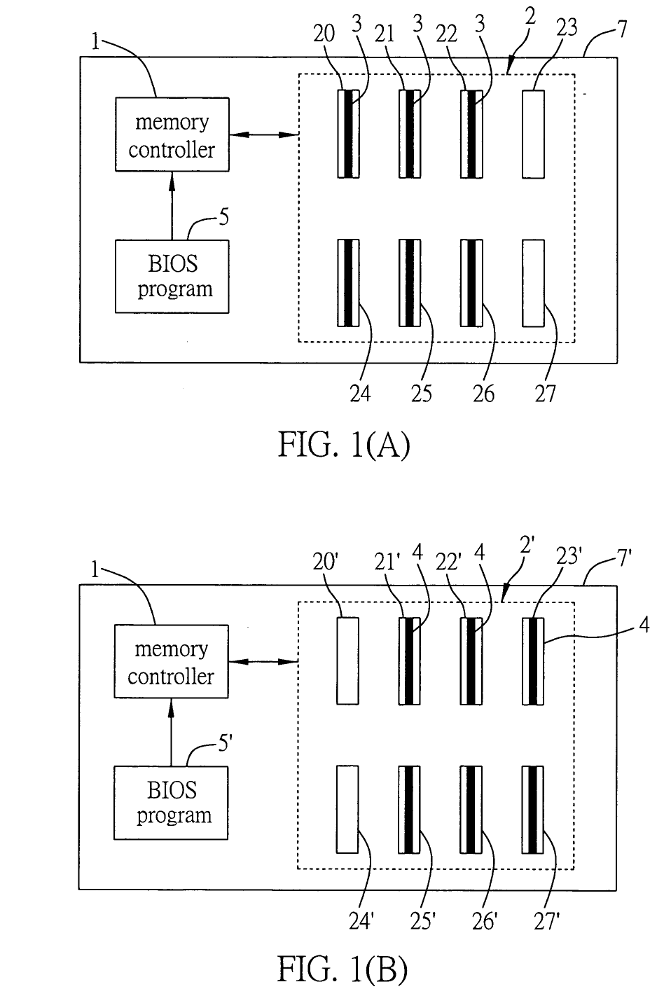

FIG. 2 is a block diagram showing a basic construction of a memory controller controlling access of a DDR-I DIMM or a DDR-II DIMM using the same BIOS program according to a method for controlling access of a dynamic random access memory module according to the present invention; and

FIG. 3 is a flowchart showing a method for controlling access of a dynamic random access memory module according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

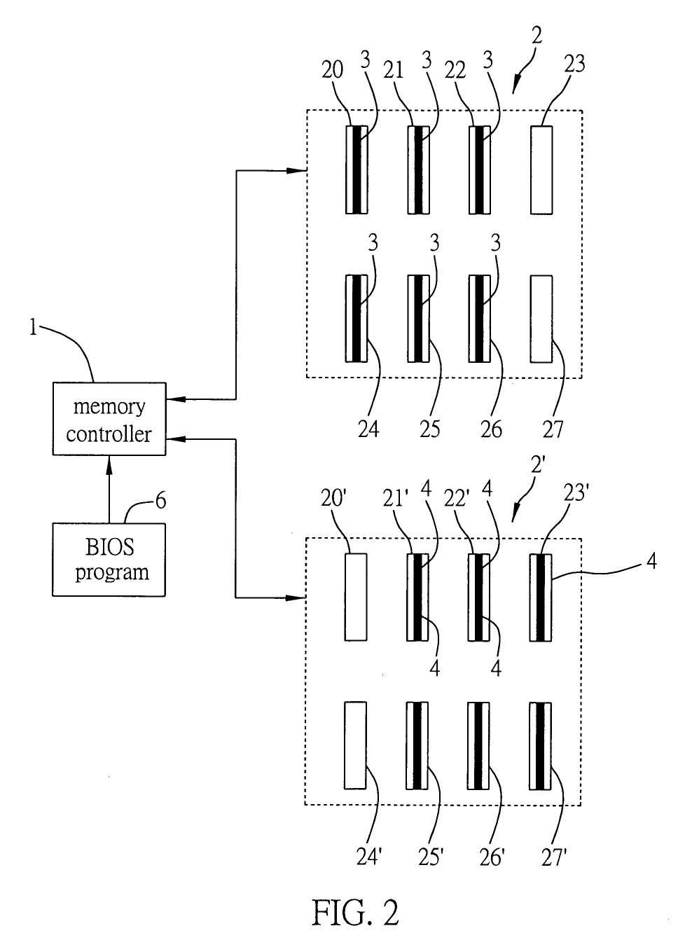

FIG. 2 is a block diagram showing a basic construction of a memory controller controlling access of a DDR-I DRAM DIMM (abbreviated as DDR-I DIMM) or a DDR-II DRAM DIMM (abbreviated as DDR-II DIMM) using the same BIOS program according to the present invention. In the present embodiment, the method for controlling the DRAM module comprises components such as a memory controller 1, a BIOS program 6 and a DDR-I DIMM slot area 2 or a DDR-II DIMM slot area 2′. These components are provided on a substrate (not shown), such that electronic devices (such as notebook computers, desktop computers, servers and workstations) installed with the substrate can control access of the DDR-I DIMM or the DDR-II DIMM using the same BIOS program. It is noted that the substrate may further comprise other various functional units. Further, only components related to the present invention are demonstrated in order to simplify the drawing and the description. Thus, other unrelated components including hardware architecture such as a south bridge and a north bridge are illustrated.

The DRAMs on the substrate of the electronic device all have the same DRAM specification. In other words, the substrate has a consistent DRAM specification. The present embodiment is further described with a DDR-I DRAM or a DDR-II DRAM as an example. Further, corresponding dual in-line memory module (DIMM) slots are provided on the substrate to match with different DRAM specifications. That is, appearances of DIMM slots corresponding to different DRAM specifications differ from each other to provide a fool-proof design function that ensures installation of a DRAM with a correct specification.

In the present embodiment, the DDR-I DIMM module slot area 2 and the DDR-II DIMM module slot area 2′ both comprise 8 DIMM slots (20, 21 . . . 27 and 20′, 21′ and 27′). A DDR-I DIMM 3 is installed in each of the DIMM slots (20, 21, 22, 24, 25 and 26) in the DDR-I DIMM module slot area 2 and a DDR-II DIMM 4 is installed in each of the DIMM slots (21′, 22′, 23′, 25′, 26′ and 27′) in the DDR-II DIMM module slot area 2′. Further, each of the DIMMs (20, 21, 22, 24, 25, 26, 21′, 22′, 23′, 25′, 26′ and 27′) is provided with a memory such as EEPROM (not shown) for memorizing DIMM parameters, i.e. serial presence detect (SPD) data. The SPD data of the DIMM comprises a memory type field having a value for determining whether the DIMM is of a DDR-I or DDR-II type. Furthermore, each of the DIMM slots comprises a system management (SM) bus, which comprises 2 signal lines, one data line and one clock line, for connecting to the slot, so that the SPD data of the DIMM can be accessed via the SM bus using an I2C protocol. Moreover, I2C addresses of the DIMM slot are constrained to A0H, A2H, A4H, A6H, A8H, AAH, ACH and AEH according to the specification of the DIMM. Moreover, the number of the DIMM slot is not limited to eight as shown in the present embodiment, there may be six or four DIMM slots depending on different embodiments.

Further, the memory controller 1 in the present embodiment is a Lindenhurst memory chipset from Intel Corporation. As the substrate is of a single DRAM specification, the BIOS program only needs to scan the memory type field in the SPD data of each of the DIMM slots (20, 21 . . . 27 and 20′, 21′ . . . 27′) to determine if the DRAM DIMM installed in the DIMM slot is of the DDR-I DIMM 3 or DDR-II DIMM 4 specification. The SPD data has a standard definition (defined in PC SDRAM serial presence detect), wherein a byte 2 data represents a memory type with values 07 and 08 representing the DDR-I DIMM and the DDR-II DIMM specifications, respectively.

Accordingly, BIOS reads the byte 2 (memory type field) value of the SPD data memorized in the memory installed in each of the DIMM slots (20, 21 . . . 27 and 20′, 21′ . . . 27′) by scanning to determine the specification of the DRAM DIMM currently installed in the DIMM slot, and to read data (i.e. program or data) corresponding to the specification of the DRAM DIMM from the BIOS program 6, such that a memory initialization is accomplished for the electronic device during a booting procedure. The foregoing BIOS program and memory initialization process of the computer device are essential components and procedures required prior to operating a common computer system and are known by one skilled in the pertinent art. Thus, operating functions and internal architecture thereof will not be further described.

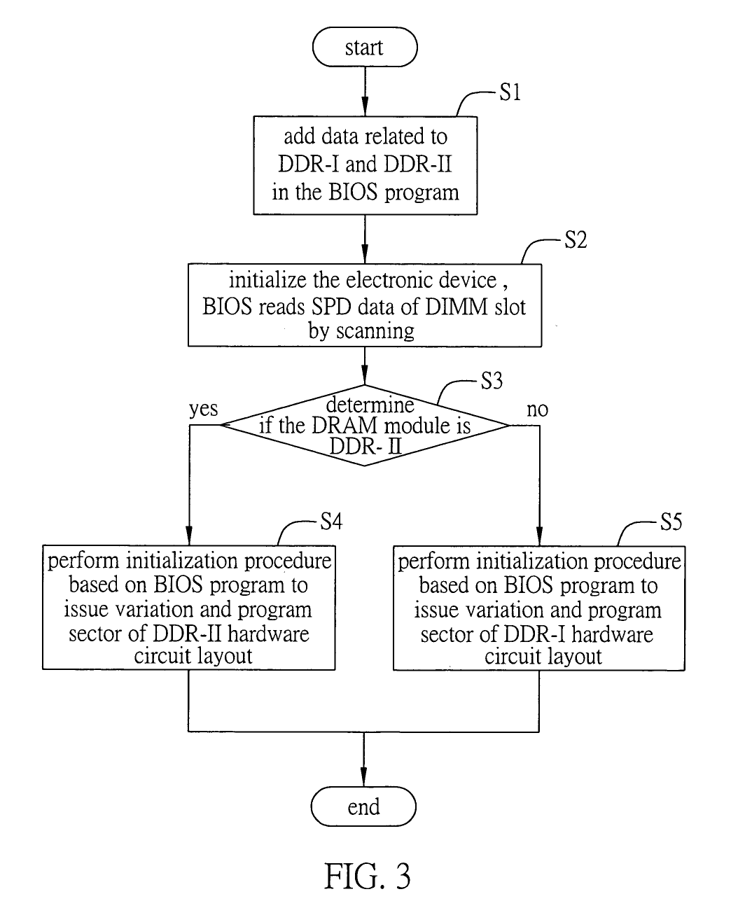

FIG. 3 is a flowchart showing a method for controlling access of a dynamic random access memory module according to the present invention. As shown in the diagram, step S1 is performed. Since the DDR-I DIMM and the DDR-II DIMM are characterized with different features, they have different requirements for hardware trace arrangement such as a configuration of DIMM CS (chip select), I2C addresses of the DIMM slot, a clock control method, a shared or individual CKE pin module and the amount of the DIMM. Therefore, data related to the DDR-I DIMM 3 and the DDR-II DIMM 4 is incorporated in the BIOS program 6 in advance according to features of the DDR-I DRAM and the DDR-II DRAM. Next, the method proceeds to step S2.

In step S2, a memory initialization process is performed by the substrate of the electronic device according to the BIOS program 6, such that the memory controller 1 can access the DIMM slot (i.e. the DDR-I DIMM slot area 2) for installing the DDR-I DIMM 3 or the DIMM slot (i.e. the DDR-II DIMM slot area 2′) for installing the DDR-II DIMM 4. Also, SPD data is read from all of the DRAM DIMM slots. In other words, a value (i.e. byte 2) in a memory type field of the SPD data is scanned and acquired using BIOS (via the I2C addresses A0H, A2H, A4H, A6H, A8H, AAH, ACH, and AEH). Therefore, it can be determined whether the DIMM slot area is installed with the DDR-I DIMM 3 or the DDR-II DIMM 4 according to the value before proceeding to step S3.

In Step S3, the value (i.e. byte 2) in the memory type field of the SPD data is read by BIOS to determine whether the DIMM slot is installed with the DDR-I DIMM 3 or the DDR-II DIMM 4. (that is, the DIMM slot area is installed with the DDR-I DIMM if the byte 2 value is 07 whereas the DIMM slot area is installed with the DDR-II DIMM if the byte 2 value is 08.) So, if the current DRAM module is determined by the memory controller 1 to be the DDR-II DIMM 4, Step S4 is performed. Otherwise, Step S5 is performed instead.

In Step S4, DRAM DIMM related data corresponding to the DDR-II DIMM specification are read from the BIOS program 6 after the DDR-II specification is determined. For example, the DRAM DIMM related data can be variables and program segments for declaring hardware trace arrangement of the DDR-II DIMM. Thus, the memory controller 1 can perform access control for the DDR-II DIMM installed in the DIMM slot according to the DDR-II DIMM related data.

In Step S5, the DRAM DIMM related data corresponding to the DDR-I DIMM specification are read from the BIOS program 6 after the DDR-I DIMM specification is determined. For example, the DRAM DIMM related data can be variables and program segments for declaring hardware trace arrangement of the DDR-I DIMM. Thus, the memory controller 1 can perform access control for the DDR-I DIMM installed in the DIMM slot according to the read relevant data of the DDR-I DIMM.

Accordingly, the method for controlling access of a dynamic random access memory module incorporates data related to the DDR-I DIMM and the DDR-II DIMM in the original BIOS program 6 according to features of the DDR-I DIMM and the DDR-II DIMM. Then, BIOS reads the SPD data of the DIMM slots (via the I2C addresses A0H, A2H . . . and AEH) by scanning during the memory initialization process, so as to determine the specification of DRAM. Thus, a desirable substrate which supports the DDR-I DIMM or the DDR-II DIMM with a memory controller can be designed and fabricated at will via a single BIOS program by electronic product manufacturers. Therefore, the present invention effectively improves from inconveniences in BIOS program designs, BIOS program burning and a substrate testing when the DDR-I DIMM or the DDR-II DIMM is accessed by the electronic product manufacturers using the memory controller.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A method for controlling access of a dynamic random access memory (DRAM) module applicable to a substrate provided with at least one of DRAM module slots of first and second specifications, a memory controller and a basic input/output system (BIOS) program, so as to control access of one of a first DRAM module installed in the DRAM module slot of the first specification and a second DRAM module installed in the DRAM module slot of the second specification, the method at least comprising steps of:
having the BIOS program store data related to the first DRAM module and the second DRAM module;
having the substrate perform a memory initialization process according to the BIOS program;
having the memory controller access the DRAM module slot provided on the substrate during the memory initialization process and to read a data value memorized in a memory type field by the DRAM module via 12C addresses of the DRAM module, so as to determine whether the DRAM module installed in the DRAM module slot is the first DRAM module or the second DRAM module; and
having the memory controller to read corresponding data related to the DRAM module from the BIOS program with the DRAM module, so as to enable the memory controller for accessing the DRAM module installed in the DRAM module slot according to the read data related to the DRAM module.

2. The method of claim 1, wherein the memory module slot is a dual in-line memory module (DIMM) slot.

3. The method of claim 2, wherein the data value in the memory type field memorized by the DRAM module is a byte 2 data value of Serial Presence Detect (SPD) data.

4. The method of claim 3, wherein the DRAM module is a DDR-I DIMM when the byte 2 data value is 07, and the DRAM module is a DDR-II DIMM when the byte 2 data value is 08.

5. The method of claim 3, wherein the SPD data is accessed by the DRAM module slot using an I2C protocol via a system management (SM) bus.

6. The method of claim 3, wherein the SPD data is memorized in an EEPROM.

7. The method of claim 1, wherein the first DRAM module is a DDR-I DRAM DIMM.

8. The method of claim 1, wherein the second DRAM module is a DDR-II DRAM DIMM.

9. The method of claim 1, wherein the memory controller is a Lindenhurst memory chipset from Intel Corporation.
